(19) United States
(12) Patent Application Publication
(10) Pub. No.: US 2025/0024456 A1
(43) Pub. Date: Jan. 16, 2025

(54) SIGNALING ASSOCIATED WITH UPLINK RESOURCE MUTING

(71) Applicant: QUALCOMM Incorporated, San Diego, CA (US)

(72) Inventors: Qian ZHANG, Basking Ridge, NJ (US); Yan ZHOU, San Diego, CA (US)

(21) Appl. No.: 18/352,065

(22) Filed: Jul. 13, 2023

(51) Int. Cl. H04W 72/23; H04L 5/00

(52) U.S. Cl. CPC H04W 72/23; H04L 5/0048

(57) ABSTRACT

Various aspects of the present disclosure generally relate to wireless communication. In some aspects, an UE may transmit, to a first network node, capability signaling associated with an uplink resource muting, the capability signaling indicating that the UE is capable of muting an uplink resource during a transmission of a reference signal from a second network node for an inter-network-node cross-link interference (CLI) measurement. The UE may receive, from the first network node, an indication associated with the uplink resource muting in accordance with the capability signaling. Numerous other aspects are described.

### FIELD OF THE DISCLOSURE

Aspects of the present disclosure generally relate to wireless communication and to techniques and apparatuses for signaling associated with uplink resource muting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes one or more memories storing processor-executable code; and one or more processors coupled with the one or more memories, at least one processor of the one or more processors configured to cause the UE to: transmit, to a first network node, capability signaling associated with an uplink resource muting, the capability signaling indicating that the UE is capable of muting an uplink resource during a transmission of a reference signal from a second network node for an inter-network-node cross-link interference (CLI) measurement; and receive, from the first network node, an indication associated with the uplink resource muting in accordance with the capability signaling.

In some implementations, an apparatus for wireless communication at a first network node includes one or more memories storing processor-executable code; and one or more processors coupled with the one or more memories, at least one processor of the one or more processors configured to cause the first network node to: receive capability signaling associated with an uplink resource muting, the capability signaling indicating that a UE is capable of muting an uplink resource during a transmission of a reference signal from a second network node for an inter-network-node CLI measurement; and transmit an indication associated with the uplink resource muting in accordance with the capability signaling.

In some implementations, a method of wireless communication performed at a UE includes transmitting, to a first network node, capability signaling associated with an uplink resource muting, the capability signaling indicating that the UE is capable of muting an uplink resource during a transmission of a reference signal from a second network node for an inter-network-node CLI measurement; and receiving, from the first network node, an indication associated with the uplink resource muting in accordance with the capability signaling.

In some implementations, a method of wireless communication performed at a first network node includes receiving capability signaling associated with an uplink resource muting, the capability signaling indicating that a UE is capable of muting an uplink resource during a transmission of a reference signal from a second network node for an inter-network-node CLI measurement; and transmitting an indication associated with the uplink resource muting in accordance with the capability signaling.

In some implementations, a non-transitory computer-readable medium storing a set of instructions for wireless communication includes one or more instructions that, when executed by one or more processors of a UE, cause the UE to: transmit, to a first network node, capability signaling associated with an uplink resource muting, the capability signaling indicating that the UE is capable of muting an uplink resource during a transmission of a reference signal from a second network node for an inter-network-node CLI measurement; and receive, from the first network node, an indication associated with the uplink resource muting in accordance with the capability signaling.

In some implementations, a non-transitory computer-readable medium storing a set of instructions for wireless communication includes one or more instructions that, when executed by one or more processors of a first network node, cause the first network node to: receive capability signaling associated with an uplink resource muting, the capability signaling indicating that a UE is capable of muting an uplink resource during a transmission of a reference signal from a second network node for an inter-network-node CLI measurement; and transmit an indication associated with the uplink resource muting in accordance with the capability signaling.

In some implementations, an apparatus for wireless communication includes means for transmitting, to a first network node, capability signaling associated with an uplink resource muting, the capability signaling indicating that the apparatus is capable of muting an uplink resource during a transmission of a reference signal from a second network node for an inter-network-node CLI measurement; and means for receiving, from the first network node, an indication associated with the uplink resource muting in accordance with the capability signaling.

In some implementations, a first apparatus for wireless communication includes means for receiving capability signaling associated with an uplink resource muting, the capability signaling indicating that a UE is capable of muting an uplink resource during a transmission of a reference signal from a second apparatus for an inter-network-node CLI measurement; and means for transmitting an indication associated with the uplink resource muting in accordance with the capability signaling.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full duplex (FD) communications, in accordance with the present disclosure.

FIG. 5 is a diagram illustrating examples of FD communications, in accordance with the present disclosure.

FIGS. 6-7 are diagrams illustrating examples of cross-link interference (CLI), in accordance with the present disclosure.

FIG. 8 is a diagram illustrating an example associated with signaling associated with uplink resource muting, in accordance with the present disclosure.

FIGS. 9-10 are diagrams illustrating example processes associated with signaling associated with uplink resource muting, in accordance with the present disclosure.

FIGS. 11-12 are diagrams of example apparatuses for wireless communication, in accordance with the present disclosure.

### DETAILED DESCRIPTION

A first network node (e.g., a victim network node) may receive a cross-link interference (CLI) reference signal from a second network node (e.g., an aggressor network node). The first network node may measure the CLI reference signal in order to determine a CLI level caused by the second network node. In order to accurately measure the CLI reference signal to obtain the CLI level, the first network node may mute an uplink transmission from a user equipment (UE) associated with the first network node, such that an entire uplink channel at a given time is dedicated for measuring the CLI reference signal. The uplink transmission may be muted when a timing of the uplink transmission corresponds to a timing of the CLI reference signal. The UE and the first network node may be associated with a same cell. When the uplink transmission is not muted, an accuracy of a CLI reference signal measurement may be degraded, which may result in a less accurate measurement of the CLI level. A muting of the uplink transmission may be referred to as an uplink resource muting, such that certain uplink resources are not used for the uplink transmission in order to improve a measurement accuracy of the CLI reference signal. The uplink resource muting may be a non-transparent uplink resource muting, in which case the uplink resource muting is known to the UE.

However, some UEs may not be capable of supporting non-transparent uplink resource muting. The first network node may be unaware of whether the UE supports the non-transparent uplink resource muting or does not support the non-transparent uplink resource muting. Further, when the UE does support the non-transparent uplink resource muting, the UE may not be configured with the new uplink muting pattern. The UE may be unaware of which uplink muting pattern should be used to support the non-transparent uplink resource muting because the UE may not be configured with the new uplink muting pattern. As a result, the UE may not follow the non-transparent uplink resource muting pattern, and the UE may perform an uplink transmission at a time during which an uplink resource should be muted, thereby negatively affecting a measurement accuracy of a CLI reference signal. Without an accurate measurement of the CLI reference signal, the first network node may be unable to accurately measure the network-node-to-network-node CLI, which may degrade a performance of the first network node.

Various aspects relate generally to signaling associated with uplink resource muting. Some aspects more specifically relate to signaling associated with a non-transparent uplink resource muting. In some examples, a UE may transmit, to a first network node, capability signaling associated with an uplink resource muting. The capability signaling may indicate that the UE is capable of muting an uplink resource during a transmission of a reference signal for an inter-network-node CLI measurement. The capability signaling may indicate whether the UE supports resource block (RB)-level uplink resource muting patterns and/or resource element (RE)-level uplink resource muting patterns. The UE may receive, from the first network node, an indication associated with the uplink resource muting in accordance with the capability signaling. The indication associated with the uplink resource muting may indicate a periodic uplink resource muting pattern, an aperiodic uplink resource muting pattern, or a predefined uplink resource muting pattern index.

Particular aspects of the subject matter described in this disclosure can be implemented to realize one or more of the following potential advantages. In some examples, by implementing signaling associated with uplink resource muting, the described techniques can be used by a UE to determine which uplink resource is muted, and the UE may refrain from performing an uplink transmission on the muted uplink resource. The UE may be aware of which uplink muting pattern should be used to support a non-transparent uplink resource muting because the UE may be configured with the uplink muting pattern. The UE may follow the non-transparent uplink resource muting, and the UE may not perform the uplink transmission at a time during which the uplink resource is muted. As a result, the first network node may be able to receive and accurately measure a reference signal associated with inter-network-node CLI measurement when the uplink resource is muted. When the UE avoids performing the uplink transmission when the uplink resource is muted, a measurement accuracy of the reference signal may be improved. With an accurate measurement of the reference signal, the first network node may be able to accurately measure a network-node-to-network-node CLI, which may improve a performance of the first network node because the first network node may be able to select an appropriate remedial action based at least in part on the accurate network-node-to-network-node CLI measurement.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

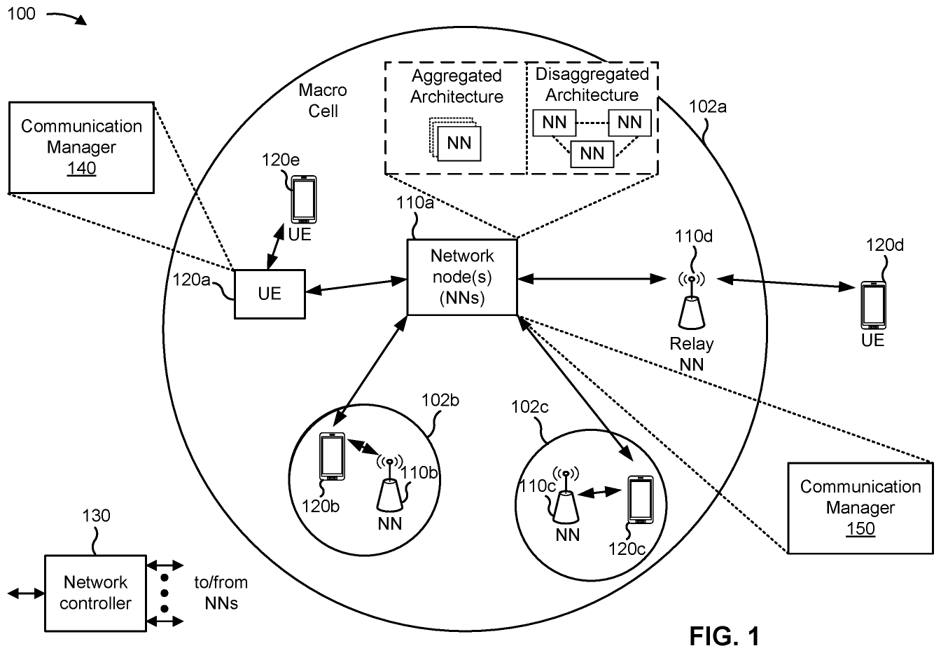

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may transmit, to a first network node, capability signaling associated with an uplink resource muting, the capability signaling indicating that the UE is capable of muting an uplink resource during a transmission of a reference signal from a second network node for an inter-network-node CLI measurement; and receive, from the first network node, an indication associated with the uplink resource muting in accordance with the capability signaling. Additionally, or alternatively, the communication manager 140 may perform one or more other operations described herein.

In some aspects, a first network node (e.g., network node 110a) may include a communication manager 150. As described in more detail elsewhere herein, the communication manager 150 may receive capability signaling associated with an uplink resource muting, the capability signaling indicating that a UE is capable of muting an uplink resource during a transmission of a reference signal from a second network node for an inter-network-node CLI measurement; and transmit an indication associated with the uplink resource muting in accordance with the capability signaling. Additionally, or alternatively, the communication manager 150 may perform one or more other operations described herein.

As indicated above, FIG. 1 is provided as an example. Other examples may differ from what is described with regard to FIG. 1.

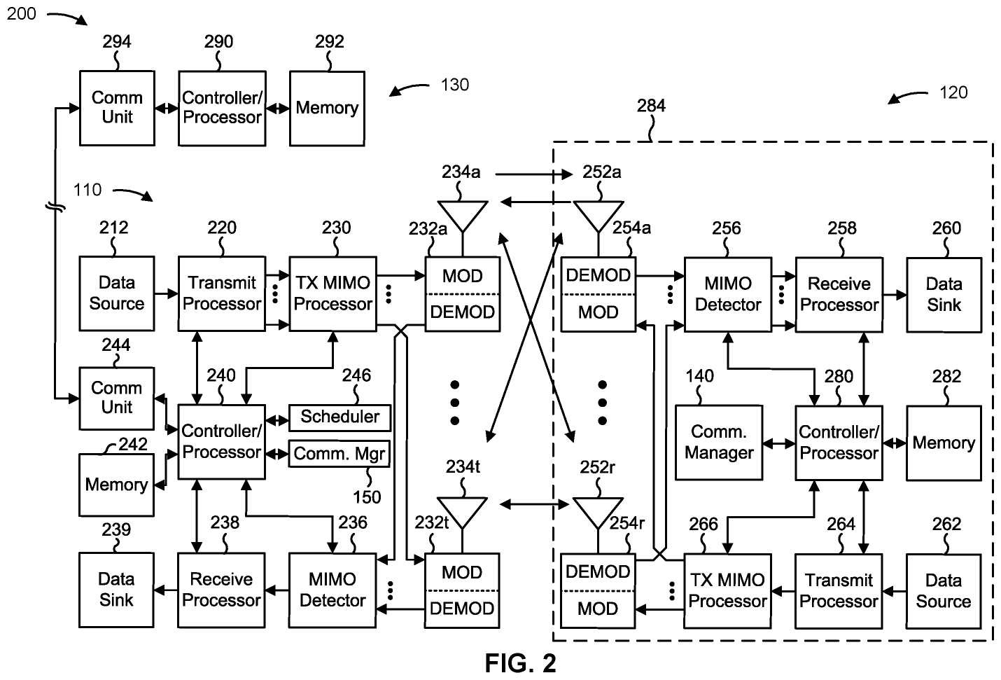

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

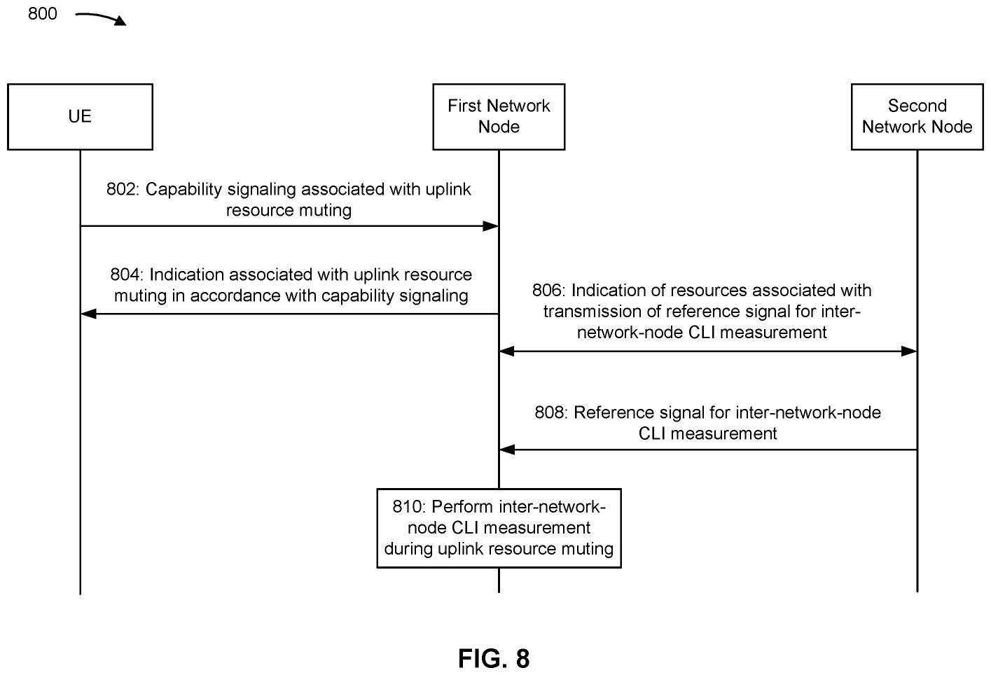

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

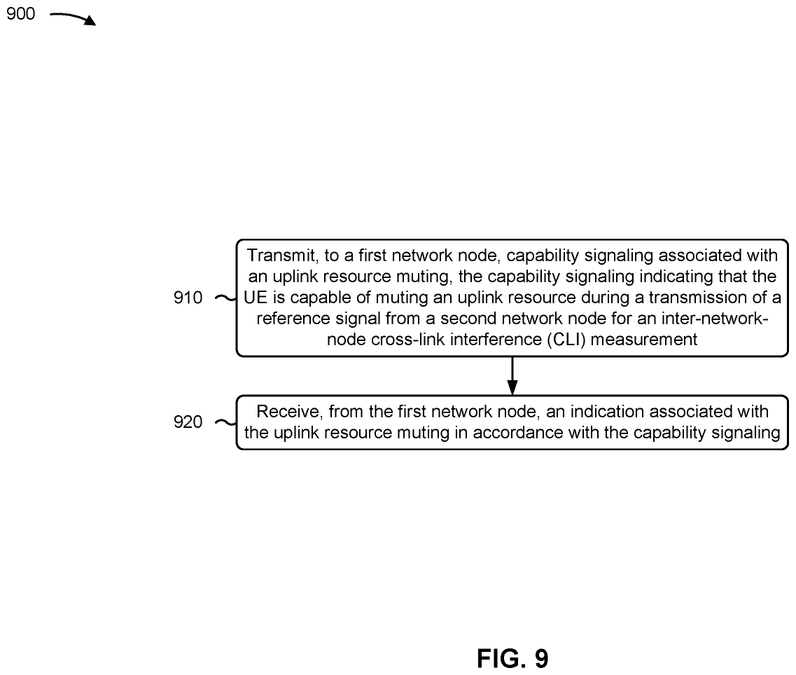

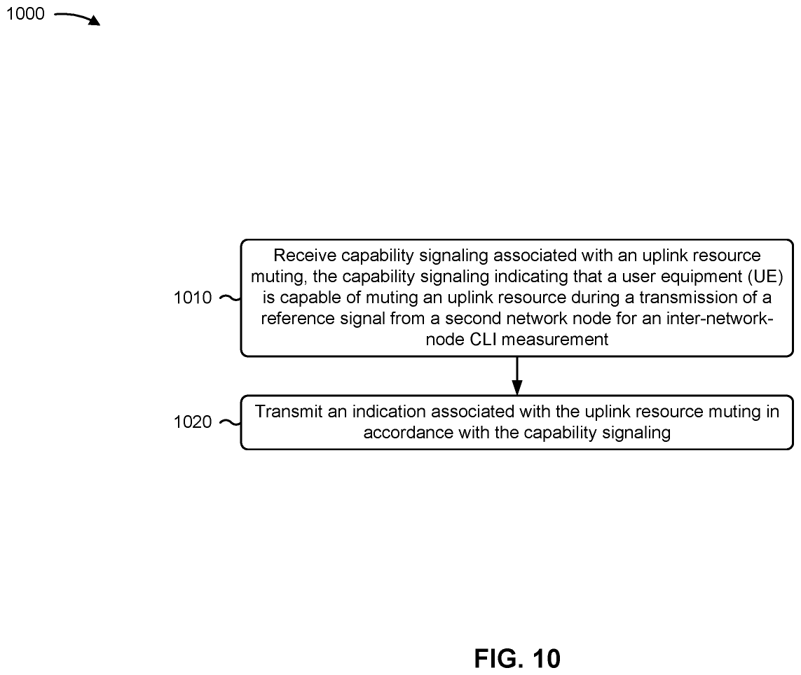

The controller/processor 240 of the network node 110, the controller/processor 280 of the UE 120, and/or any other component(s) of FIG. 2 may perform one or more techniques associated with signaling associated with uplink resource muting, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to a first network node, capability signaling associated with an uplink resource muting, the capability signaling indicating that the UE is capable of muting an uplink resource during a transmission of a reference signal from a second network node for an inter-network-node CLI measurement; and/or means for receiving, from the first network node, an indication associated with the uplink resource muting in accordance with the capability signaling. In some aspects, the means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first network node (e.g., network node 110a) includes means for receiving capability signaling associated with an uplink resource muting, the capability signaling indicating that a UE is capable of muting an uplink resource during a transmission of a reference signal from a second network node for an inter-network-node CLI measurement; and/or means for transmitting an indication associated with the uplink resource muting in accordance with the capability signaling. In some aspects, the means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

In some aspects, one or more of multiple memories may be configured to store processor-executable code that, when executed, may configure the one or more processors to perform various functions described herein (as part of a processing system). In some other implementations, the processing system may be pre-configured to perform various functions described herein.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

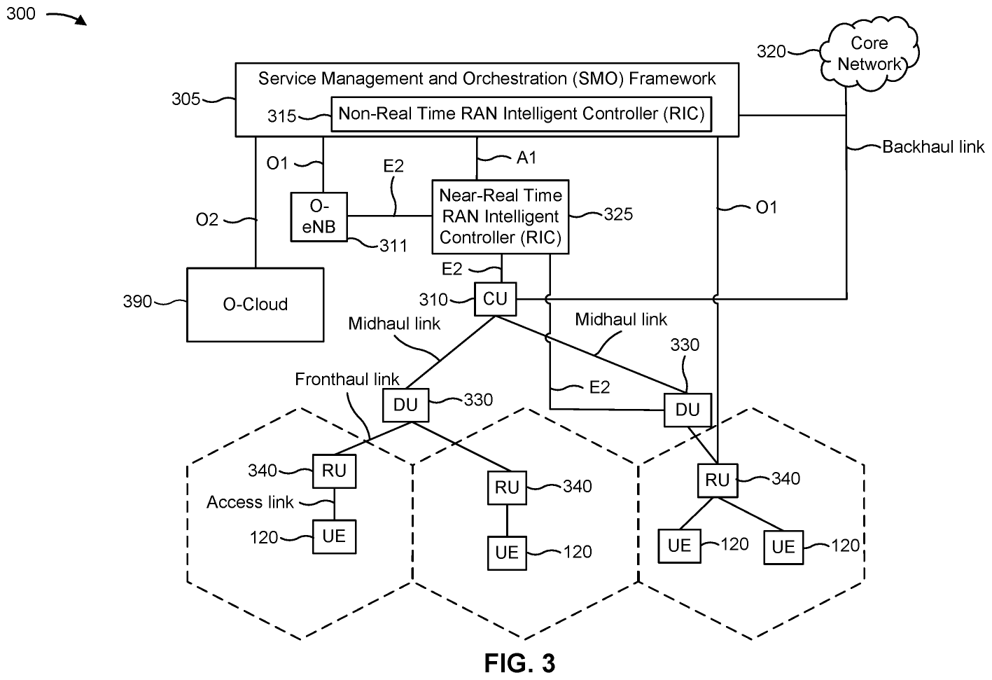

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A full duplex (FD) operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve an SBFD (or flexible duplex) operation, in which a transmission and a reception may occur at the same time but on different frequency resources. A downlink resource may be separated from an uplink resource in a frequency domain. In the SBFD operation, no downlink and uplink overlap in frequency may occur.

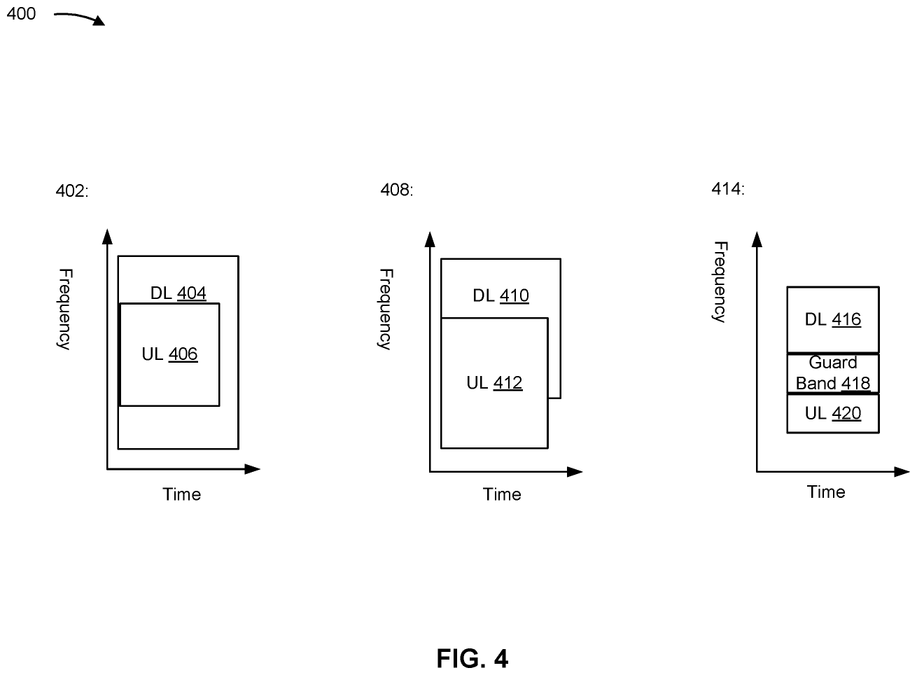

FIG. 4 is a diagram illustrating examples 400 of FD communications, in accordance with the present disclosure.

As shown by reference number 402, a downlink resource 404 and an uplink resource 406 may share the same IBFD time/frequency resource based at least in part on a full overlap. As shown by reference number 408, a downlink resource 410 and an uplink resource 412 may share the same IBFD time/frequency resource based at least in part on a partial overlap. As shown by reference number 414, a downlink resource 416 and an uplink resource 420 may be associated with a same time but different frequencies. The downlink resource 416 and the uplink resource 420 may be separated by a guard band 418.

As indicated above, FIG. 4 is provided as an example. Other examples may differ from what is described with regard to FIG. 4.

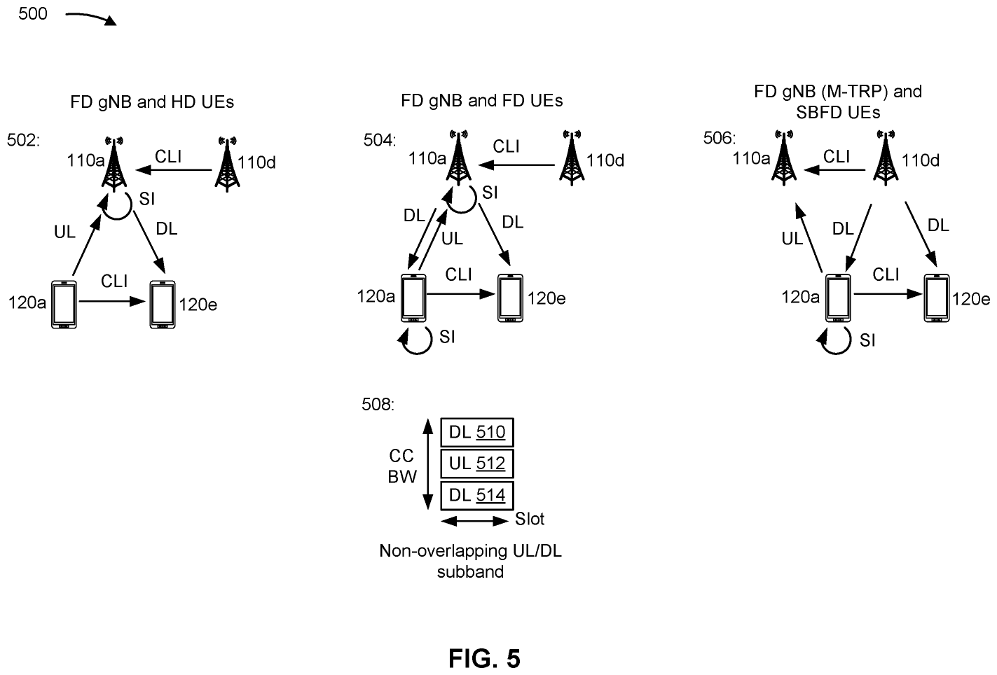

FIG. 5 is a diagram illustrating examples 500 of FD communications, in accordance with the present disclosure.

As shown by reference number 502, an FD network node (e.g., network node 110a) may communicate with half duplex (HD) UEs. The FD network node may be subjected to cross-link interference (CLI) from another FD network node (e.g., network node 110d). The CLI from the other FD network node may be inter-network node CLI. The FD network node may experience self-interference (SI). The FD network node may receive an uplink transmission from a first HD UE (e.g., UE 120a), and the FD network node may transmit a downlink transmission to a second HD UE (e.g., UE 120e). The FD network node may receive the uplink transmission and transmit the downlink transmission on the same slot (e.g., a simultaneous reception/transmission). The second HD UE may be subjected to CLI from the first HD UE (e.g., inter-UE CLI).

As shown by reference number 504, an FD network node (e.g., network node 110a) may communicate with FD UEs. The FD network node may be subjected to CLI from another FD network node (e.g., network node 110d). The FD network node may experience SI. The FD network node may transmit a downlink transmission to a first FD UE (e.g., UE 120a), and the FD network node may receive an uplink transmission from the first FD UE at the same time as the downlink transmission. The FD network node may transmit a downlink transmission to a second FD UE (e.g., UE 120e). The second HD UE may be subjected to CLI from the first HD UE. The first UE may experience SI.

As shown by reference number 506, a first FD network node (e.g., network node 110a), which may be associated with multiple transmission reception points (TRPs), may communicate with SBFD UEs. The first FD network node may be subjected to CLI from a second FD network node (e.g., network node 110d). The first FD network node may receive an uplink transmission from a first SBFD UE (e.g., UE 120a). The second FD network node may transmit downlink transmissions to both the first SBFD UE and a second SBFD UE (e.g., UE 120e). The second SBFD UE may be subjected to CLI from the first SBFD UE. The first SBFD UE may experience SI.

As shown by reference number 508, an SBFD slot may be associated with a non-overlapping uplink/downlink sub-band. The SBFD slot may be associated with a simultaneous transmission/reception of a downlink/uplink on a sub-band basis. Within a component carrier bandwidth, an uplink resource 512 may be in between, in a frequency domain, a first downlink resource 510 and a second downlink resource 514. The first downlink resource 510, the second downlink resource 514, and the uplink resource 512 may all be associated with the same time.

An SBFD operation may increase an uplink duty cycle, which may result in a latency reduction (e.g., a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaptation according to uplink/downlink traffic in a robust manner.

As indicated above, FIG. 5 is provided as an example. Other examples may differ from what is described with regard to FIG. 5.

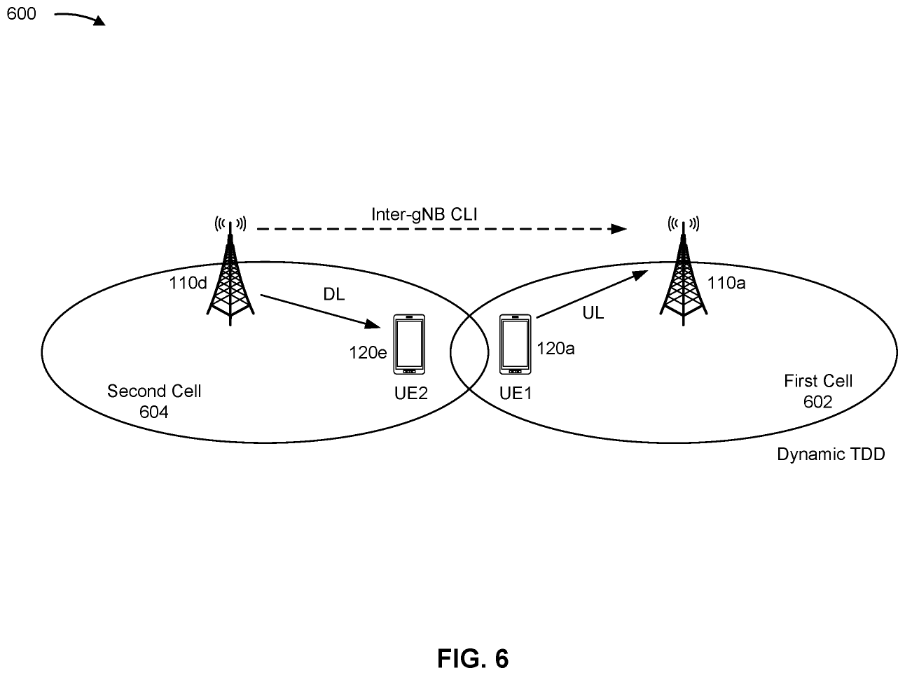

FIG. 6 is a diagram illustrating an example 600 of CLI, in accordance with the present disclosure.

As shown in FIG. 6, in a dynamic time domain duplexing (TDD) scenario, a first network node 110a in a first cell 602 may receive an uplink transmission from a first UE 120a. A second network node 110d in a second cell 604 may transmit a downlink transmission to a second UE 120e. The first network node 110a may experience inter-network-node (e.g., inter-gNB) CLI from the second network node 110d. The first network node 110a may be a victim network node, and the second network node 110d may be an aggressor network node. The inter-network-node CLI may negatively affect an uplink performance of the first network node 110a.

As indicated above, FIG. 6 is provided as an example. Other examples may differ from what is described with regard to FIG. 6.

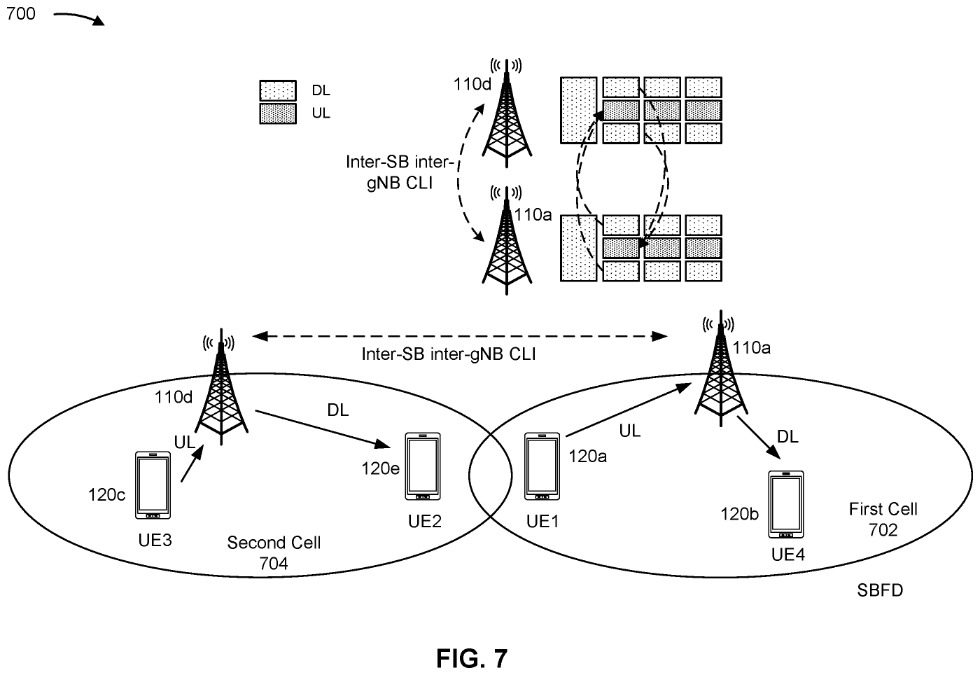

FIG. 7 is a diagram illustrating an example 700 of CLI, in accordance with the present disclosure.

As shown in FIG. 7, in an SBFD scenario, a first network node 110a in a first cell 702 may receive an uplink transmission from a first UE 120a in the first cell 702. The first network node 110a may transmit a downlink transmission to a fourth UE 120b in the first cell 702. A second network node 110d in a second cell 704 may receive an uplink transmission from a third UE 120c in the second cell 704. The second network node 110d may transmit a downlink transmission to a second UE 120e in the second cell 704. The first network node 110a may cause an inter-subband (SB) inter-network-node CLI to the second network node 110d, and vice versa. Downlink transmissions of the first network node 110a may cause the inter-SB inter-network-node (e.g., inter-gNB) CLI with an uplink transmission of the second network node 110d. Downlink transmissions of the second network node 110d may cause the inter-SB inter-network-node CLI with an uplink transmission of the first network node 110a.

As indicated above, FIG. 7 is provided as an example. Other examples may differ from what is described with regard to FIG. 7.

A first network node (e.g., a victim network node) may receive a CLI reference signal from a second network node (e.g., an aggressor network node). The first network node may measure the CLI reference signal in order to determine a CLI level caused by the second network node. The CLI reference signal may be a non-zero-power (NZP) channel state information reference signal (CSI-RS) or a synchronization signal block (SSB). In order to accurately measure the CLI reference signal to obtain the CLI level, the first network node may mute an uplink transmission from a UE associated with the first network node, such that an entire uplink channel at a given time is dedicated for measuring the CLI reference signal. The uplink transmission may be muted when a timing of the uplink transmission corresponds to a timing of the CLI reference signal. The UE and the first network node may be associated with a same cell. When the uplink transmission is not muted, an accuracy of a CLI reference signal measurement may be degraded, which may result in a less accurate measurement of the CLI level. A muting of the uplink transmission may be referred to as an uplink resource muting, such that certain uplink resources are not used for the uplink transmission to improve a measurement accuracy of the CLI reference signal.

The CLI reference signal may be periodic, and during a periodic occasion of a CLI reference signal transmission, an uplink resource may be muted. An uplink resource that is muted should not be used by the UE to perform the uplink transmission. In other words, the UE may refrain from performing the uplink transmission using the muted uplink resource, and instead may wait until a non-muted uplink resource is available to perform the uplink transmission.

For a network-node-to-network-node co-channel CLI measurement and/or channel measurement (e.g., inter-gNB CLI channel measurements/reporting), the uplink resource muting may be based at least in part on a transparent uplink resource muting or a non-transparent uplink resource muting. The uplink resource muting may be transparent to the UE, and may be based at least in part on a first network node scheduling. Alternatively, the first network node may cancel particular uplink resources. For example, the first network node may cancel particular resource blocks (RBs) of a symbol or an entire symbol for the purpose of CLI reference signal measurement. The non-transparent uplink resource muting may be associated with a new uplink muting pattern. With the new uplink muting pattern, the UE may be aware of particular uplink resources that are muted, and the UE may not use those particular uplink resources for the uplink transmission. The particular uplink resources may correspond to the CLI reference signal in a time domain. The UE may be able to use remaining uplink resources for the uplink transmission because the remaining uplink resources may not conflict with the CLI reference signal.

The uplink resource muting may be used to measure a network-node-to-network-node (e.g., gNB-to-gNB) CLI level with less interference from an uplink resource. The uplink resource muting may be used to measure a network-node-to-network-node channel with less interference from an uplink resource. The uplink resource muting may be used to measure a network-node-to-network-node CLI interference covariance matrix with less interference from an uplink resource. The network-node-to-network-node CLI interference covariance matrix may be associated with a channel estimation.

However, some UEs may not be capable of supporting non-transparent uplink resource muting. The first network node may be unaware of whether the UE supports the non-transparent uplink resource muting or does not support the non-transparent uplink resource muting. Further, when the UE does support the non-transparent uplink resource muting, the UE may not be configured with the new uplink muting pattern. The UE may be unaware of which uplink muting pattern should be used to support the non-transparent uplink resource muting because the UE may not be configured with the new uplink muting pattern. As a result, the UE may not follow the non-transparent uplink resource muting pattern, and the UE may perform an uplink transmission at a time during which an uplink resource should be muted, thereby negatively affecting a measurement accuracy of a CLI reference signal. Without an accurate measurement of the CLI reference signal, the first network node may be unable to accurately measure the network-node-to-network-node CLI, which may degrade a performance of the first network node.

In various aspects of techniques and apparatuses described herein, a UE may transmit, to a first network node, capability signaling associated with an uplink resource muting. The capability signaling may indicate that the UE is capable of muting an uplink resource during a transmission of a reference signal from a second network node for an inter-network-node CLI measurement. The capability signaling may indicate whether the UE supports RB-level and/or RE-level uplink resource muting patterns. The UE may receive, from the first network node, an indication associated with the uplink resource muting in accordance with the capability signaling. The indication associated with the uplink resource muting may indicate a periodic uplink resource muting pattern, an aperiodic uplink resource muting pattern, or a predefined uplink resource muting pattern index.

In some aspects, based at least in part on the indication, the UE may determine which uplink resource is muted, and the UE may refrain from performing an uplink transmission on the muted uplink resource. The UE may be aware of which uplink muting pattern should be used to support a non-transparent uplink resource muting because the UE may be configured with the uplink muting pattern. The UE may follow the non-transparent uplink resource muting, and the UE may not perform the uplink transmission at a time during which the uplink resource is muted. As a result, the first network node may be able to receive and accurately measure a reference signal associated with inter-network-node CLI measurement when the uplink resource is muted. When the UE avoids performing the uplink transmission when the uplink resource is muted, a measurement accuracy of the reference signal may be improved. With an accurate measurement of the reference signal, the first network node may be able to accurately measure a network-node-to-network-node CLI, which may improve a performance of the first network node because the first network node may be able to select an appropriate remedial action based at least in part on the accurate network-node-to-network-node CLI measurement.

FIG. 8 is a diagram illustrating an example 800 associated with signaling associated with uplink resource muting, in accordance with the present disclosure. As shown in FIG. 8, example 800 includes communication between a UE (e.g., UE 120), a first network node (e.g., network node 110a), and a second network node (e.g., network node 110b). In some aspects, the UE, the first network node, and the second network node may be included in a wireless network, such as wireless network 100.

In some aspects, the first network node may be a victim network node and the second network node may be an aggressor network node (e.g., the victim network node may be subjected to CLI from the aggressor network node). The first network node may be a serving network node of the UE.

As shown by reference number 802, the UE may transmit, to the first network node, capability signaling associated with an uplink resource muting. The capability signaling may indicate that the UE is capable of muting an uplink resource during a transmission of a reference signal from the second network node for an inter-network-node CLI measurement. The capability signaling may indicate whether the UE supports one or more RB-level uplink resource muting patterns or one or more RE-level uplink resource muting patterns. The capability signaling may indicate whether the UE supports an uplink rate matching associated with an RB-level uplink resource muting pattern or an RE-level uplink resource muting pattern.

In some aspects, when a non-transparent uplink resource muting defines an uplink resource muting pattern with one or more RB/RE muting patterns and/or the uplink rate matching, a UE capability signaling may be needed to signal whether the UE supports the non-transparent uplink resource muting. The UE capability signaling may indicate whether the UE supports one or more RB/RE level uplink resource muting patterns and/or uplink rate matching based at least in part on the one or more RB/RE level uplink resource muting patterns. For example, an uplink resource muting pattern may indicate that uplink resources associated with every other RE or every few REs in a symbol should be muted to enable a more accurate inter-network-node CLI measurement, and remaining UEs in the symbol may still be used for an uplink transmission to save resources for an uplink. In some aspects, an uplink resource muting at an RB/RE level may cause a non-contiguous uplink resource mapping, which may increase a peak-to-average power ratio (PAPR) with a discrete Fourier transform (DFT) waveform, and may also increase a UE complexity with potential hardware changes. Thus, the non-transparent uplink resource muting may not be supported by all new UEs. The non-transparent uplink resource muting may be an optional UE feature, and may be indicated by the UE using the UE capability signaling.

As shown by reference number 804, the UE may receive, from the first network node, an indication associated with the uplink resource muting in accordance with the capability signaling. The indication associated with the uplink resource muting may indicate a periodic uplink resource muting pattern, an aperiodic uplink resource muting pattern, or a predefined uplink resource muting pattern index.

In some aspects, the indication associated with the uplink resource muting may indicate the periodic uplink resource muting pattern. The indication of the periodic uplink resource muting pattern may indicate a time location associated with the uplink resource, a frequency location associated with the uplink resource, and/or a periodicity associated with the uplink resource. A remaining uplink resource that is not muted may be available for the uplink transmission by the UE. In some aspects, the UE may receive, from the first network node, the indication of the periodic uplink resource muting pattern in a semi-static manner via RRC signaling. The UE may receive, from the first network node, the indication of the periodic uplink resource muting pattern in a semi-persistent manner via a MAC control element (MAC-CE).

In some aspects, the indication associated with the uplink resource muting may indicate the aperiodic uplink resource muting pattern. The indication of the aperiodic uplink resource muting pattern may indicate a time location associated with the uplink resource and/or a frequency location associated with the uplink resource. The indication of the aperiodic uplink resource muting pattern may indicate a quantity of slots in which to apply the aperiodic uplink resource muting pattern and/or a time window during which to apply the aperiodic uplink resource muting pattern. A remaining uplink resource that is not muted may be available for the uplink transmission by the UE. In some aspects, the UE may receive, from the first network node, the indication of the aperiodic uplink resource muting pattern in a dynamic manner via a downlink control information (DCI). The DCI may include a new field (e.g., a dedicated field), a reserved field, or an unused field to indicate the aperiodic uplink resource muting pattern. The DCI may be associated with a DCI format that schedules a dynamic uplink transmission. The DCI may be associated with a DCI format that does not schedule data. The DCI may be a group common DCI.

In some aspects, the indication associated with the uplink resource muting may indicate the predefined uplink resource muting pattern index. The predefined uplink resource muting pattern index may be associated with one uplink resource muting pattern from a plurality of different uplink resource muting patterns with different time and frequency locations at which uplink resources are muted. The plurality of different uplink resource muting patterns may be predefined in a specification. The UE may receive, from the first network node, the indication that indicates the predefined uplink resource muting pattern index via RRC signaling, a MAC-CE, or a DCI.

In some aspects, in a first option, the first network node may indicate the uplink resource muting to the UE using a periodic uplink resource muting pattern indication. The periodic uplink resource muting pattern indication may indicate the time/frequency locations and the periodicity in which the uplink resource is muted, such that the UE may be notified of which symbols and which RBs/REs are muted for the uplink transmission, and the UE may be notified of the periodicity in which the uplink resource is muted. The UE may use remaining uplink resources (e.g., remaining RBs/REs) for the uplink transmission. The periodic uplink resource muting pattern may be semi-statically configured by the first network node to the UE via the RRC signaling. Alternatively, the periodic uplink resource muting pattern may be semi-statically configured by the first network node to the UE via MAC-CE signaling.

In some aspects, in a second option, the first network node may indicate the uplink resource muting to the UE using an aperiodic uplink resource muting pattern indication. The aperiodic uplink resource muting pattern indication may indicate the time/frequency locations at which the uplink resource is muted, such that the UE may be notified of which symbols and which RBs/REs are muted for the uplink transmission. The UE may use remaining uplink resources (e.g., remaining RBs/REs) for the uplink transmission. In some aspects, the first network node may also indicate whether the aperiodic uplink resource muting pattern applies to multiple slots. The first network node may indicate N slots in which to apply the aperiodic uplink resource muting pattern. The first network node may indicate a time window during which to apply the aperiodic uplink resource muting pattern. In some aspects, the aperiodic uplink resource muting pattern may be dynamically indicated by the first network node to the UE via DCI signaling. The DCI may be associated with the DCI format used to schedule the dynamic uplink transmission. The DCI may include the new field (e.g., the dedicated field), the reserved field, or the unused field to define the aperiodic uplink resource muting pattern.

In some aspects, in a third option, the specification may predefine the uplink resource muting pattern. The specification may define different uplink resource muting patterns with the different time/frequency locations at which the uplink is muted. The specification may optionally define an aperiodicity of the uplink resource muting pattern. The uplink resource muting pattern may be indicated by the first network node to the UE via the predefined uplink resource muting pattern index. The first network node may indicate the predefined uplink resource muting pattern index via the RRC signaling, the MAC-CE, or the DCI, depending on the specification. In some aspects, when the predefined uplink resource muting pattern index is indicated via the DCI, the DCI may be the DCI format used to schedule the dynamic uplink transmission, or the DCI may be the DCI format used to activate an uplink configured grant (CG) physical uplink shared channel (PUSCH) transmission. The DCI may include the new field (e.g., the dedicated field), the reserved field, or the unused field to define the uplink resource muting pattern.

As shown by reference number 806, the first network node may receive, from the second network node, an indication of resources associated with the transmission of the reference signal from the second network node for the inter-network-node CLI measurement. The indication associated with the uplink resource muting may be in accordance with the indication of resources associated with the transmission of the reference signal from the second network node for the inter-network-node CLI measurement. The first network node may receive the indication of resources associated with the transmission of the reference signal based at least in part on a signaling exchange between the first network node and the second network node. Alternatively, the first network node may receive, from a central unit instead of the second network node, the indication of resources associated with the transmission of the reference signal.

As shown by reference number 808, the first network node may receive, from the second network node, the reference signal for the inter-network-node CLI measurement. The reference signal may be an NZP CSI-RS or an SSB. The first network node may receive the reference signal based at least in part on the indication of resources associated with the transmission of the reference signal.

As shown by reference number 810, the first network node may perform the inter-network-node CLI measurement associated with the reference signal during the uplink resource muting. The first network node may perform the inter-network-node CLI measurement when the uplink resource is muted and is not being used by the UE to perform the uplink transmission. As a result, the first network node may be able to measure the reference signal with an increased measurement accuracy. The first network node may use the inter-network-node CLI measurement when initiating a remedial action to reduce CLI from the second network node, thereby improving a performance of the first network node.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with signaling associated with uplink resource muting.

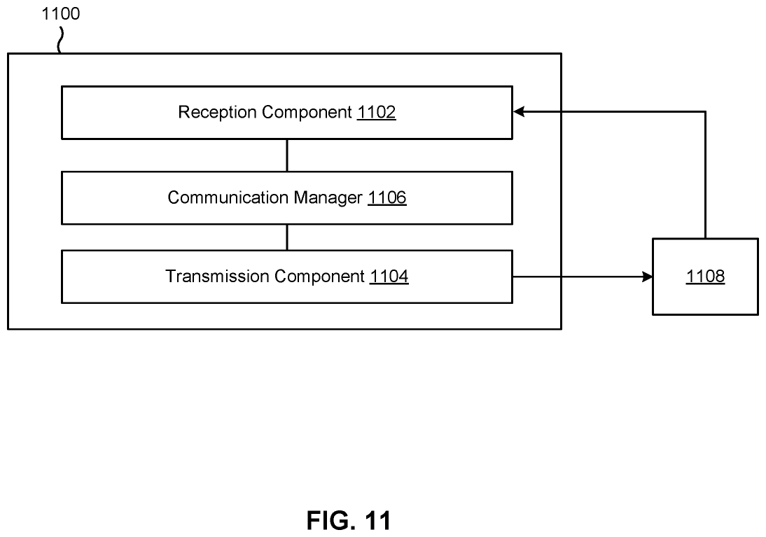

As shown in FIG. 9, in some aspects, process 900 may include transmitting, to a first network node, capability signaling associated with an uplink resource muting, the capability signaling indicating that the UE is capable of muting an uplink resource during a transmission of a reference signal from a second network node for an inter-network-node CLI measurement (block 910). For example, the UE (e.g., using transmission component 1104 and/or communication manager 1106, depicted in FIG. 11) may transmit, to a first network node, capability signaling associated with an uplink resource muting, the capability signaling indicating that the UE is capable of muting an uplink resource during a transmission of a reference signal from a second network node for an inter-network-node CLI measurement, as described above.

As further shown in FIG. 9, in some aspects, process 900 may include receiving, from the first network node, an indication associated with the uplink resource muting in accordance with the capability signaling (block 920). For example, the UE (e.g., using reception component 1102 and/or communication manager 1106, depicted in FIG. 11) may receive, from the first network node, an indication associated with the uplink resource muting in accordance with the capability signaling, as described above.

Process 900 may include additional aspects, such as any single aspect or any combination of aspects described below and/or in connection with one or more other processes described elsewhere herein.

In a first aspect, the capability signaling indicates whether the UE supports one or more RB-level uplink resource muting patterns or one or more RE-level uplink resource muting patterns.

In a second aspect, alone or in combination with the first aspect, the capability signaling indicates whether the UE supports an uplink rate matching associated with an RB-level uplink resource muting pattern or an RE-level uplink resource muting pattern.

In a third aspect, alone or in combination with one or more of the first and second aspects, the indication associated with the uplink resource muting indicates a periodic uplink resource muting pattern.

In a fourth aspect, alone or in combination with one or more of the first through third aspects, the indication of the periodic uplink resource muting pattern indicates one or more of: a time location associated with the uplink resource, a frequency location associated with the uplink resource, or a periodicity associated with the uplink resource.

In a fifth aspect, alone or in combination with one or more of the first through fourth aspects, the indication of the periodic uplink resource muting pattern is received in a semi-static manner via RRC signaling, or the indication of the periodic uplink resource muting pattern is received in a semi-persistent manner via a MAC-CE.

In a sixth aspect, alone or in combination with one or more of the first through fifth aspects, the reference signal is one of an NZP CSI-RS or an SSB.

In a seventh aspect, alone or in combination with one or more of the first through sixth aspects, the indication associated with the uplink resource muting indicates an aperiodic uplink resource muting pattern.

In an eighth aspect, alone or in combination with one or more of the first through seventh aspects, the indication of the aperiodic uplink resource muting pattern indicates one or more of: a time location associated with the uplink resource, or a frequency location associated with the uplink resource.

In a ninth aspect, alone or in combination with one or more of the first through eighth aspects, the indication of the aperiodic uplink resource muting pattern indicates one or more of: a quantity of slots in which to apply the aperiodic uplink resource muting pattern, or a time window during which to apply the aperiodic uplink resource muting pattern.

In a tenth aspect, alone or in combination with one or more of the first through ninth aspects, the indication of the aperiodic uplink resource muting pattern is received in a dynamic manner via a DCI, and the DCI includes one of a dedicated field, a reserved field, or an unused field to indicate the aperiodic uplink resource muting pattern, and the DCI is associated with a DCI format that schedules a dynamic uplink transmission, the DCI is associated with a DCI format that does not schedule data, or the DCI is a group common DCI.

In an eleventh aspect, alone or in combination with one or more of the first through tenth aspects, the indication associated with the uplink resource muting indicates a predefined uplink resource muting pattern index.

In a twelfth aspect, alone or in combination with one or more of the first through eleventh aspects, the predefined uplink resource muting pattern index is associated with one uplink resource muting pattern from a plurality of different uplink resource muting patterns with different time and frequency locations at which uplink resources are muted, and the plurality of different uplink resource muting patterns are predefined in a specification.

In a thirteenth aspect, alone or in combination with one or more of the first through twelfth aspects, the indication that indicates the predefined uplink resource muting pattern index is received via RRC signaling, a MAC-CE, or a DCI.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a first network node, in accordance with the present disclosure. Example process 1000 is an example where the first network node (e.g., first network node 110) performs operations associated with signaling associated with uplink resource muting.

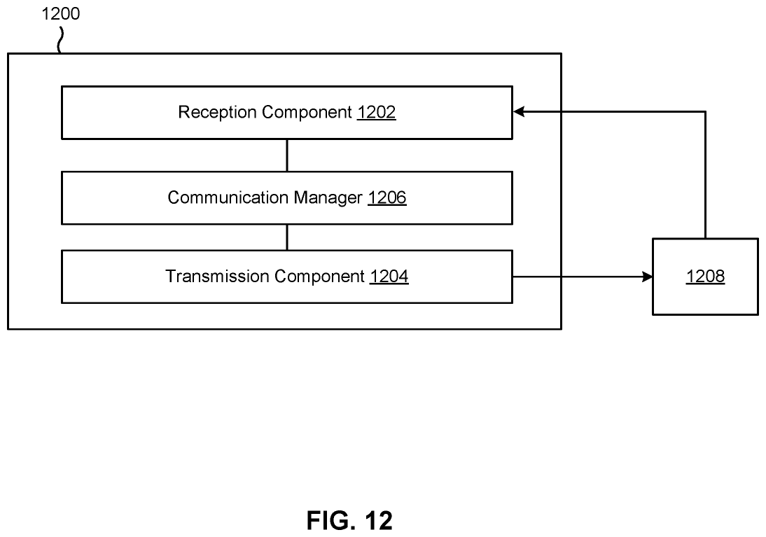

As shown in FIG. 10, in some aspects, process 1000 may include receiving capability signaling associated with an uplink resource muting, the capability signaling indicating that a UE is capable of muting an uplink resource during a transmission of a reference signal from a second network node for an inter-network-node CLI measurement (block 1010). For example, the first network node (e.g., using reception component 1202 and/or communication manager 1206, depicted in FIG. 12) may receive capability signaling associated with an uplink resource muting, the capability signaling indicating that a UE is capable of muting an uplink resource during a transmission of a reference signal from a second network node for an inter-network-node CLI measurement, as described above.

As further shown in FIG. 10, in some aspects, process 1000 may include transmitting an indication associated with the uplink resource muting in accordance with the capability signaling (block 1020). For example, the first network node (e.g., using transmission component 1204 and/or communication manager 1206, depicted in FIG. 12) may transmit an indication associated with the uplink resource muting in accordance with the capability signaling, as described above.

Process 1000 may include additional aspects, such as any single aspect or any combination of aspects described below and/or in connection with one or more other processes described elsewhere herein.

In a first aspect, the capability signaling indicates whether the UE supports one or more RB-level uplink resource muting patterns or one or more RE-level uplink resource muting patterns.

In a second aspect, alone or in combination with the first aspect, the capability signaling indicates whether the UE supports an uplink rate matching associated with an RB-level uplink resource muting pattern or an RE-level uplink resource muting pattern.

In a third aspect, alone or in combination with one or more of the first and second aspects, the indication associated with the uplink resource muting indicates a periodic uplink resource muting pattern.

In a fourth aspect, alone or in combination with one or more of the first through third aspects, the indication of the periodic uplink resource muting pattern indicates one or more of: a time location associated with the uplink resource, a frequency location associated with the uplink resource, or a periodicity associated with the uplink resource.

In a fifth aspect, alone or in combination with one or more of the first through fourth aspects, the indication of the periodic uplink resource muting pattern is transmitted in a semi-static manner via RRC signaling, or the indication of the periodic uplink resource muting pattern is transmitted in a semi-persistent manner via a MAC-CE.

In a sixth aspect, alone or in combination with one or more of the first through fifth aspects, the reference signal is one of an NZP CSI-RS or an SSB.

In a seventh aspect, alone or in combination with one or more of the first through sixth aspects, the indication associated with the uplink resource muting indicates an aperiodic uplink resource muting pattern.

In an eighth aspect, alone or in combination with one or more of the first through seventh aspects, the indication of the aperiodic uplink resource muting pattern indicates one or more of: a time location associated with the uplink resource, or a frequency location associated with the uplink resource.

In a ninth aspect, alone or in combination with one or more of the first through eighth aspects, the indication of the aperiodic uplink resource muting pattern indicates one or more of: a quantity of slots in which to apply the aperiodic uplink resource muting pattern, or a time window during which to apply the aperiodic uplink resource muting pattern.

In a tenth aspect, alone or in combination with one or more of the first through ninth aspects, the indication of the aperiodic uplink resource muting pattern is transmitted in a dynamic manner via a DCI, and the DCI includes one of a dedicated field, a reserved field, or an unused field to indicate the aperiodic uplink resource muting pattern, and the DCI is associated with a DCI format that schedules a dynamic uplink transmission, the DCI is associated with a DCI format that does not schedule data, or the DCI is a group common DCI.

In an eleventh aspect, alone or in combination with one or more of the first through tenth aspects, the indication associated with the uplink resource muting indicates a predefined uplink resource muting pattern index.

In a twelfth aspect, alone or in combination with one or more of the first through eleventh aspects, the predefined uplink resource muting pattern index is associated with one uplink resource muting pattern from a plurality of different uplink resource muting patterns with different time and frequency locations at which uplink resources are muted, and the plurality of different uplink resource muting patterns are predefined in a specification.

In a thirteenth aspect, alone or in combination with one or more of the first through twelfth aspects, the indication that indicates the predefined uplink resource muting pattern index is transmitted via RRC signaling, a MAC-CE, or a DCI.

In a fourteenth aspect, alone or in combination with one or more of the first through twelfth thirteenth, process 1000 includes receiving, from the second network node, an indication of resources associated with the transmission of the reference signal for the inter-network-node CLI measurement, and the indication associated with the uplink resource muting is in accordance with the indication of resources associated with the transmission of the reference signal for the inter-network-node CLI measurement.

In a fifteenth aspect, alone or in combination with one or more of the first through twelfth fourteenth, process 1000 includes receiving, from a central unit, an indication of resources associated with the transmission of the reference signal for the inter-network-node CLI measurement, and the indication associated with the uplink resource muting is in accordance with the indication of resources associated with the transmission of the reference signal for the inter-network-node CLI measurement.

In a sixteenth aspect, alone or in combination with one or more of the first through twelfth fifteenth, process 1000 includes receiving, from the second network node, the reference signal for the inter-network-node CLI measurement, the reference signal being one of an NZP CSI-RS or an SSB; and performing the inter-network-node CLI measurement associated with the reference signal during the uplink resource muting.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a first network node, capability signaling associated with an uplink resource muting, the capability signaling indicating that the UE is capable of muting an uplink resource during a transmission of a reference signal from a second network node for an inter-network-node CLI measurement. The reception component 1102 may receive, from the first network node, an indication associated with the uplink resource muting in accordance with the capability signaling.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a first network node, or a first network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the first network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the first network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the first network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive capability signaling associated with an uplink resource muting, the capability signaling indicating that a UE is capable of muting an uplink resource during a transmission of a reference signal from a second network node for an inter-network-node CLI measurement. The transmission component 1204 may transmit an indication associated with the uplink resource muting in accordance with the capability signaling.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed at a user equipment (UE), comprising: transmitting, to a first network node, capability signaling associated with an uplink resource muting, the capability signaling indicating that the UE is capable of muting an uplink resource during a transmission of a reference signal from a second network node for an inter-network-node cross-link interference (CLI) measurement; and receiving, from the first network node, an indication associated with the uplink resource muting in accordance with the capability signaling.

Aspect 2: The method of Aspect 1, wherein the capability signaling indicates whether the UE supports one or more resource block (RB)-level uplink resource muting patterns or one or more resource element (RE)-level uplink resource muting patterns.

Aspect 3: The method of any of Aspects 1-2, wherein the capability signaling indicates whether the UE supports an uplink rate matching associated with a resource block (RB)-level uplink resource muting pattern or a resource element (RE)-level uplink resource muting pattern.

Aspect 4: The method of any of Aspects 1-3, wherein the indication associated with the uplink resource muting indicates a periodic uplink resource muting pattern.

Aspect 5: The method of Aspect 4, wherein the indication of the periodic uplink resource muting pattern indicates one or more of: a time location associated with the uplink resource, a frequency location associated with the uplink resource, or a periodicity associated with the uplink resource.

Aspect 6: The method of Aspect 4, wherein: the indication of the periodic uplink resource muting pattern is received in a semi-static manner via radio resource control (RRC) signaling; or the indication of the periodic uplink resource muting pattern is received in a semi-persistent manner via a medium access control control element (MAC-CE).

Aspect 7: The method of Aspect 4, wherein the reference signal is one of a non-zero-power (NZP) channel state information reference signal (CSI-RS) or a synchronization signal block (SSB).

Aspect 8: The method of any of Aspects 1-7, wherein the indication associated with the uplink resource muting indicates an aperiodic uplink resource muting pattern.

Aspect 9: The method of Aspect 8, wherein the indication of the aperiodic uplink resource muting pattern indicates one or more of: a time location associated with the uplink resource or a frequency location associated with the uplink resource.

Aspect 10: The method of Aspect 8, wherein the indication of the aperiodic uplink resource muting pattern indicates one or more of: a quantity of slots in which to apply the aperiodic uplink resource muting pattern or a time window during which to apply the aperiodic uplink resource muting pattern.

Aspect 11: The method of Aspect 8, wherein: the indication of the aperiodic uplink resource muting pattern is received in a dynamic manner via a downlink control information (DCI), and the DCI includes one of a dedicated field, a reserved field, or an unused field to indicate the aperiodic uplink resource muting pattern; and the DCI is associated with a DCI format that schedules a dynamic uplink transmission; the DCI is associated with a DCI format that does not schedule data; or the DCI is a group common DCI.

Aspect 12: The method of any of Aspects 1-11, wherein the indication associated with the uplink resource muting indicates a predefined uplink resource muting pattern index.

Aspect 13: The method of Aspect 12, wherein the predefined uplink resource muting pattern index is associated with one uplink resource muting pattern from a plurality of different uplink resource muting patterns with different time and frequency locations at which uplink resources are muted, and the plurality of different uplink resource muting patterns are predefined in a specification.

Aspect 14: The method of Aspect 12, wherein the indication that indicates the predefined uplink resource muting pattern index is received via radio resource control (RRC) signaling, a medium access control control element (MAC-CE), or a downlink control information (DCI).

Aspect 15: A method of wireless communication performed at a first network node, comprising: receiving capability signaling associated with an uplink resource muting, the capability signaling indicating that a user equipment (UE) is capable of muting an uplink resource during a transmission of a reference signal from a second network node for an inter-network-node cross-link interference (CLI) measurement; and transmitting an indication associated with the uplink resource muting in accordance with the capability signaling.

Aspect 16: The method of Aspect 15, wherein the capability signaling indicates whether the UE supports one or more resource block (RB)-level uplink resource muting patterns or one or more resource element (RE)-level uplink resource muting patterns.

Aspect 17: The method of any of Aspects 15-16, wherein the capability signaling indicates whether the UE supports an uplink rate matching associated with a resource block (RB)-level uplink resource muting pattern or a resource element (RE)-level uplink resource muting pattern.

Aspect 18: The method of any of Aspects 15-17, wherein the indication associated with the uplink resource muting indicates a periodic uplink resource muting pattern.

Aspect 19: The method of Aspect 18, wherein the indication of the periodic uplink resource muting pattern indicates one or more of: a time location associated with the uplink resource, a frequency location associated with the uplink resource, or a periodicity associated with the uplink resource.

Aspect 20: The method of Aspect 18, wherein: the indication of the periodic uplink resource muting pattern is transmitted in a semi-static manner via radio resource control (RRC) signaling; or the indication of the periodic uplink resource muting pattern is transmitted in a semi-persistent manner via a medium access control control element (MAC-CE).

Aspect 21: The method of Aspect 15, wherein the reference signal is one of a non-zero-power (NZP) channel state information reference signal (CSI-RS) or a synchronization signal block (SSB).

Aspect 22: The method of any of Aspects 15-21, wherein the indication associated with the uplink resource muting indicates an aperiodic uplink resource muting pattern.

Aspect 23: The method of Aspect 22, wherein the indication of the aperiodic uplink resource muting pattern indicates one or more of: a time location associated with the uplink resource or a frequency location associated with the uplink resource.

Aspect 24: The method of Aspect 22, wherein the indication of the aperiodic uplink resource muting pattern indicates one or more of: a quantity of slots in which to apply the aperiodic uplink resource muting pattern or a time window during which to apply the aperiodic uplink resource muting pattern.

Aspect 25: The method of Aspect 22, wherein: the indication of the aperiodic uplink resource muting pattern is transmitted in a dynamic manner via a downlink control information (DCI), and the DCI includes one of a dedicated field, a reserved field, or an unused field to indicate the aperiodic uplink resource muting pattern; and the DCI is associated with a DCI format that schedules a dynamic uplink transmission; the DCI is associated with a DCI format that does not schedule data; or the DCI is a group common DCI.

Aspect 26: The method of any of Aspects 15-25, wherein the indication associated with the uplink resource muting indicates a predefined uplink resource muting pattern index.

Aspect 27: The method of Aspect 26, wherein the predefined uplink resource muting pattern index is associated with one uplink resource muting pattern from a plurality of different uplink resource muting patterns with different time and frequency locations at which uplink resources are muted, and the plurality of different uplink resource muting patterns are predefined in a specification.

Aspect 28: The method of Aspect 26, wherein the indication that indicates the predefined uplink resource muting pattern index is transmitted via radio resource control (RRC) signaling, a medium access control control element (MAC-CE), or a downlink control information (DCI).

Aspect 29: The method of any of Aspects 15-28, further comprising: receiving, from the second network node, an indication of resources associated with the transmission of the reference signal for the inter-network-node CLI measurement, and the indication associated with the uplink resource muting is in accordance with the indication of resources associated with the transmission of the reference signal for the inter-network-node CLI measurement.

Aspect 30: The method of any of Aspects 15-29, further comprising: receiving, from a central unit, an indication of resources associated with the transmission of the reference signal for the inter-network-node CLI measurement, and the indication associated with the uplink resource muting is in accordance with the indication of resources associated with the transmission of the reference signal for the inter-network-node CLI measurement.

Aspect 31: The method of any of Aspects 15-30, further comprising: receiving, from the second network node, the reference signal for the inter-network-node CLI measurement, the reference signal being one of a non-zero-power (NZP) channel state information reference signal (CSI-RS) or a synchronization signal block (SSB); and performing the inter-network-node CLI measurement associated with the reference signal during the uplink resource muting.

Aspect 32: An apparatus for wireless communication at a device, comprising a processor; memory coupled with the processor; and instructions stored in the memory and executable by the processor to cause the apparatus to perform the method of one or more of Aspects 1-14.

Aspect 33: A device for wireless communication, comprising a memory and one or more processors coupled to the memory, the one or more processors configured to perform the method of one or more of Aspects 1-14.

Aspect 34: An apparatus for wireless communication, comprising at least one means for performing the method of one or more of Aspects 1-14.

Aspect 35: A non-transitory computer-readable medium storing code for wireless communication, the code comprising instructions executable by a processor to perform the method of one or more of Aspects 1-14.

Aspect 36: A non-transitory computer-readable medium storing a set of instructions for wireless communication, the set of instructions comprising one or more instructions that, when executed by one or more processors of a device, cause the device to perform the method of one or more of Aspects 1-14.

Aspect 37: An apparatus for wireless communication at a device, comprising a processor; memory coupled with the processor; and instructions stored in the memory and executable by the processor to cause the apparatus to perform the method of one or more of Aspects 15-31.

Aspect 38: A device for wireless communication, comprising a memory and one or more processors coupled to the memory, the one or more processors configured to perform the method of one or more of Aspects 15-31.

Aspect 39: An apparatus for wireless communication, comprising at least one means for performing the method of one or more of Aspects 15-31.

Aspect 40: A non-transitory computer-readable medium storing code for wireless communication, the code comprising instructions executable by a processor to perform the method of one or more of Aspects 15-31.

Aspect 41: A non-transitory computer-readable medium storing a set of instructions for wireless communication, the set of instructions comprising one or more instructions that, when executed by one or more processors of a device, cause the device to perform the method of one or more of Aspects 15-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
transmit, to a first network node, capability signaling associated with an uplink resource muting, the capability signaling indicating that the UE is capable of muting an uplink resource during a transmission of a reference signal from a second network node for an inter-network-node cross-link interference (CLI) measurement; and
receive, from the first network node, an indication associated with the uplink resource muting in accordance with the capability signaling.

2. The apparatus of claim 1, wherein the capability signaling indicates whether the UE supports one or more resource block (RB)-level uplink resource muting patterns or one or more resource element (RE)-level uplink resource muting patterns.

3. The apparatus of claim 1, wherein the indication associated with the uplink resource muting indicates a periodic uplink resource muting pattern.

4. The apparatus of claim 3, wherein the indication of the periodic uplink resource muting pattern indicates one or more of: a time location associated with the uplink resource, a frequency location associated with the uplink resource, or a periodicity associated with the uplink resource.

5. The apparatus of claim 3, wherein:
the indication of the periodic uplink resource muting pattern is received in a semi-static manner via radio resource control (RRC) signaling; or
the indication of the periodic uplink resource muting pattern is received in a semi-persistent manner via a medium access control control element (MAC-CE).

6. The apparatus of claim 1, wherein the reference signal is a non-zero-power (NZP) channel state information reference signal (CSI-RS) or a synchronization signal block (SSB).

7. The apparatus of claim 1, wherein the indication associated with the uplink resource muting indicates an aperiodic uplink resource muting pattern.

8. The apparatus of claim 7, wherein the indication of the aperiodic uplink resource muting pattern indicates one or more of: a time location associated with the uplink resource or a frequency location associated with the uplink resource.

9. The apparatus of claim 7, wherein the indication of the aperiodic uplink resource muting pattern indicates one or more of: a quantity of slots in which to apply the aperiodic uplink resource muting pattern or a time window during which to apply the aperiodic uplink resource muting pattern.

10. The apparatus of claim 7, wherein:
the indication of the aperiodic uplink resource muting pattern is received in a dynamic manner via a downlink control information (DCI), and the DCI includes one of a dedicated field, a reserved field, or an unused field to indicate the aperiodic uplink resource muting pattern; and
the DCI is associated with a DCI format that schedules a dynamic uplink transmission;
the DCI is associated with a DCI format that does not schedule data; or
the DCI is a group common DCI.

11. A method of wireless communication performed at a user equipment (UE), comprising:
transmitting, to a first network node, capability signaling associated with an uplink resource muting, the capability signaling indicating that the UE is capable of muting an uplink resource during a transmission of a reference signal from a second network node for an inter-network-node cross-link interference (CLI) measurement; and
receiving, from the first network node, an indication associated with the uplink resource muting in accordance with the capability signaling.

12. The method of claim 11, wherein the capability signaling indicates whether the UE supports an uplink rate matching associated with a resource block (RB)-level uplink resource muting pattern or a resource element (RE)-level uplink resource muting pattern.

13. The method of claim 11, wherein the indication associated with the uplink resource muting indicates a predefined uplink resource muting pattern index.

14. The method of claim 13, wherein the predefined uplink resource muting pattern index is associated with one uplink resource muting pattern from a plurality of different uplink resource muting patterns with different time and frequency locations at which uplink resources are muted, and the plurality of different uplink resource muting patterns are predefined in a specification.

15. The method of claim 13, wherein the indication that indicates the predefined uplink resource muting pattern index is received via radio resource control (RRC) signaling, a medium access control control element (MAC-CE), or a downlink control information (DCI).

16. An apparatus for wireless communication at a first network node, comprising:
one or more memories storing processor-executable code; and
one or more processors coupled with the one or more memories, at least one processor of the one or more processors configured to cause the first network node to:
receive capability signaling associated with an uplink resource muting, the capability signaling indicating that a user equipment (UE) is capable of muting an uplink resource during a transmission of a reference signal from a second network node for an inter-network-node cross-link interference (CLI) measurement; and
transmit an indication associated with the uplink resource muting in accordance with the capability signaling.

17. The apparatus of claim 16, wherein the capability signaling indicates whether the UE supports an uplink rate matching associated with a resource block (RB)-level uplink resource muting pattern or a resource element (RE)-level uplink resource muting pattern.

18. The apparatus of claim 16, wherein the indication associated with the uplink resource muting indicates a predefined uplink resource muting pattern index.

19. The apparatus of claim 18, wherein the predefined uplink resource muting pattern index is associated with one uplink resource muting pattern from a plurality of different uplink resource muting patterns with different time and frequency locations at which uplink resources are muted, and the plurality of different uplink resource muting patterns are predefined in a specification.

20. The apparatus of claim 18, wherein the indication that indicates the predefined uplink resource muting pattern index is received via radio resource control (RRC) signaling.

21. The apparatus of claim 18, wherein the indication that indicates the predefined uplink resource muting pattern index is received via a medium access control control element (MAC-CE).

22. The apparatus of claim 18, wherein the indication that indicates the predefined uplink resource muting pattern index is received via a downlink control information (DCI).

23. The apparatus of claim 16, wherein at least one processor of the one of the one or more processors is configured to:
receive, from the second network node, an indication of resources associated with the transmission of the reference signal for the inter-network-node CLI measurement, and the indication associated with the uplink resource muting is in accordance with the indication of resources associated with the transmission of the reference signal for the inter-network-node CLI measurement.

24. The apparatus of claim 16, wherein at least one processor of the one of the one or more processors is configured to:
receive, from a central unit, an indication of resources associated with the transmission of the reference signal for the inter-network-node CLI measurement, and the indication associated with the uplink resource muting is in accordance with the indication of resources associated with the transmission of the reference signal for the inter-network-node CLI measurement.

25. The apparatus of claim 16, wherein at least one processor of the one of the one or more processors is configured to:
receive, from the second network node, the reference signal for the inter-network-node CLI measurement, the reference signal being one of a non-zero-power (NZP) channel state information reference signal (CSI-RS) or a synchronization signal block (SSB); and
perform the inter-network-node CLI measurement associated with the reference signal during the uplink resource muting.

26. A method of wireless communication performed at a first network node, comprising:
receiving capability signaling associated with an uplink resource muting, the capability signaling indicating that a user equipment (UE) is capable of muting an uplink resource during a transmission of a reference signal from a second network node for an inter-network-node cross-link interference (CLI) measurement; and
transmitting an indication associated with the uplink resource muting in accordance with the capability signaling.

27. The method of claim 26, wherein the indication associated with the uplink resource muting indicates a periodic uplink resource muting pattern.

28. The method of claim 27, wherein the indication of the periodic uplink resource muting pattern indicates one or more of: a time location associated with the uplink resource, a frequency location associated with the uplink resource, or a periodicity associated with the uplink resource.

29. The method of claim 27, wherein:
the indication of the periodic uplink resource muting pattern is received in a semi-static manner via radio resource control (RRC) signaling; or
the indication of the periodic uplink resource muting pattern is received in a semi-persistent manner via a medium access control control element (MAC-CE).

30. The method of claim 26, wherein the reference signal is a non-zero-power (NZP) channel state information reference signal (CSI-RS) or a synchronization signal block (SSB).
